(19) United States
(12) Patent Application Publication
(10) Pub. No.: US 2023/0394629 A1
(43) Pub. Date: Dec. 7, 2023

(54) REPRODUCTION METHOD FOR IMAGE

(71) Applicants: Jun Min HAN, Namyangju-si (KR); Chang Yub HAN, Namyangju-si (KR); PROJECT HAN, Bucheon-si (KR)

(72) Inventors: Jun Min HAN, Namyangju-si (KR); Chang Yub HAN, Namyangju-si (KR)

(21) Appl. No.: 18/033,328

(22) PCT Filed: Oct. 26, 2021
(86) PCT No.: PCT/KR2021/015095

§ 371 Date: Apr. 21, 2023

(30) Foreign Application Priority Data
Oct. 26, 2020 (KR) 10-2020-0139197
Apr. 27, 2021 (KR) 10-2021-0054092

(51) Int. Cl. G06T 3/60; G06F 3/04845; G06T 3/40

(52) U.S. Cl. CPC G06T 3/60; G06F 3/04845; G06T 3/40; G06T 2200/24

(57) ABSTRACT

Disclosed is a reproduction method for an image. The reproduction method for an image according to the present disclosure includes: generating a low-capacity image by rendering a photographed image of an object to be photographed by a user; and reproducing the low-capacity image in a display connected to a server or a user terminal by the user, and counterclockwise rotation which is forward rotation of the image is provided by controlling a reproduction speed of the image, and clockwise rotation which is reverse rotation of the image is provided by reversely reproducing the image.

### CROSS-REFERENCE TO RELATED APPLICATIONS

This application claims the priority of Korean Patent Application Nos. 10-2020-0139197 filed on Oct. 26, 2020 and filed on Apr. 27, 2021, in the Korean Intellectual Property Office, the disclosure of which is incorporated herein by reference.

### BACKGROUND OF THE INVENTION

### Field of the Invention

The present disclosure relates to a reproduction method for an image, and more particularly, to a reproduction method for an image for operating an image without a stop phenomenon upon speed control and magnification, and forward and reverse control of the image by touching or dragging an image in a screen of a website.

### Description of the Related Art

Currently, customers who purchase goods do not do shopping by directly visiting a store, but buy products using the Internet or smartphones.

However, when the customers visit the store and shop in person, there is an advantage in that the customers can check the goods in person and choose the goods, but if the customers are shopping in an online shopping mall, there is an advantage of eliminating the time constraints, but it is not possible to check the goods in person, so it is also true that the customers have felt uncomfortable upon ordering.

A technology that uploads a photo or an image of clothing or products on the website to enable a buyer to view the products by using the Internet or smartphones is disclosed in order to resolve the inconvenience.

In the conventional website, in order to view a scene just passed when playing the image, the image should be reproduced again or the customer should wait until a desired screen is shown again after returning a play time to a specific time in a separate UI.

As a result, whenever a stop phenomenon occurs during reverse rotation in the screen of the website, a user should close the screen of the website, and then open the screen again, convenience of the user is deteriorated, so a remedy therefor is required.

The foregoing technical configuration is a background technology to aid understanding of the present disclosure, and does not mean the prior art widely known in the technical field to which the present disclosure belongs.

### SUMMARY OF THE INVENTION

Therefore, a technical object to be achieved by the present disclosure is to provide a reproduction method for an image which can rotate an image without a stop phenomenon upon forward rotation or reverse rotation of the image in a screen of a website.

According to an aspect of the present disclosure, a reproduction method for an image may be provided, which includes: generating a low-capacity image by rendering a photographed image of an object to be photographed by a user; and reproducing the low-capacity image in a display connected to a server or a user terminal by the user, in which counterclockwise rotation which is forward rotation of the image is provided by controlling a reproduction speed of the image, and clockwise rotation which is reverse rotation of the image is provided by reversely reproducing the image.

Only when a continuous reverse reproduction event occurs and it is thus possible to change the play time of the image which is executed previously when the play time of the image is changed, changing the play time of the image is tried again, and otherwise, after the play time of the image to be changed is added, the added play time may be applied jointly when the play time of a next image is changed.

In the forward rotation, while the image is dragged by a mouse or a touch, an arbitrary dragged coordinate is obtained and a coordinate speed may be measured, and a sped of the forward rotation may be increased or decreased according to a ratio of the coordinate speed.

Magnification of the image may be provided by overlaying a current play time capture image of an original high-definition image on the image having the low-resolution.

The magnification of the image may include setting the reproduction speed of the image to ‘0’ or checking the current play time after pause when magnifying the image, importing the current playtime capture image of the original high-definition image through the server or the user terminal, and overlaying the current play time capture image on the magnified image.

The image having the low resolution may be used when not magnifying the image, and a cache image made in the server or browser may be used when magnifying the image.

According to exemplary embodiments of the present disclosure, counterclockwise rotation which is forward rotation of an image is provided by controlling a reproduction speed of the image, and clockwise rotation which is reverse rotation of the image is provided by reversely reproducing the image to rotate the image without a stop phenomenon upon forward rotation or reverse rotation of the image in a screen of a website.

Further, when a specific area is magnified in the screen of the website, an image having a low resolution is covered with a current play time capture image of an original high image quality image to securer a high-quality image screen.

Furthermore, when the specific is magnified in the screen of the website, a cache image made in a server or a browser is used, thereby obtaining a traffic reduction effect.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram schematically illustrating a reproduction method for an image according to an exemplary embodiment of the present disclosure;

FIG. 2 is a diagram schematically illustrating a screen of a smartphone to which the exemplary embodiment is applied;

FIG. 3 is a diagram schematically illustrating an image figure of the screen illustrated in FIG. 2 which is rotated in a forward direction; and

FIG. 4 is a diagram schematically illustrating the image figure of the screen illustrated in FIG. 2 which is rotated in a reverser direction.

### DETAILED DESCRIPTION OF THE PREFERRED EMBODIMENT

Hereinafter, detailed embodiments of the present disclosure will be described with reference to the drawings. In order to sufficiently appreciate operational advantages of the present disclosure and objects achieved by an exemplary embodiment of the present disclosure, accompanying drawings illustrating the exemplary embodiments of the present disclosure and contents disclosed in the accompanying drawings should be referred.

Hereinafter, a preferred embodiment of the present disclosure will be described in detail with reference to the accompanying drawings to described the present disclosure in detail. Like reference numerals presented in each drawing refer to like members.

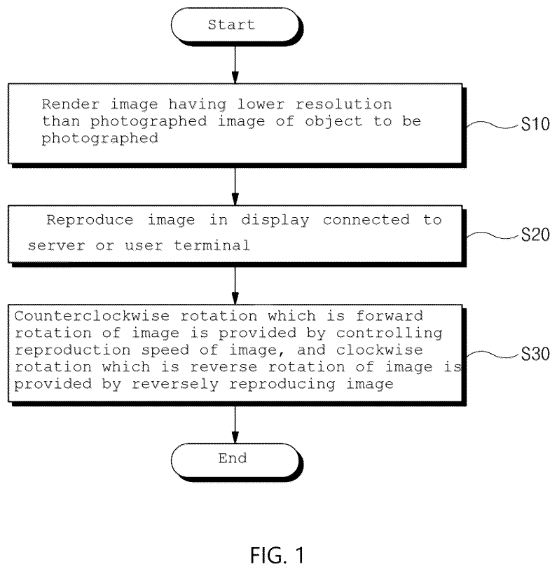

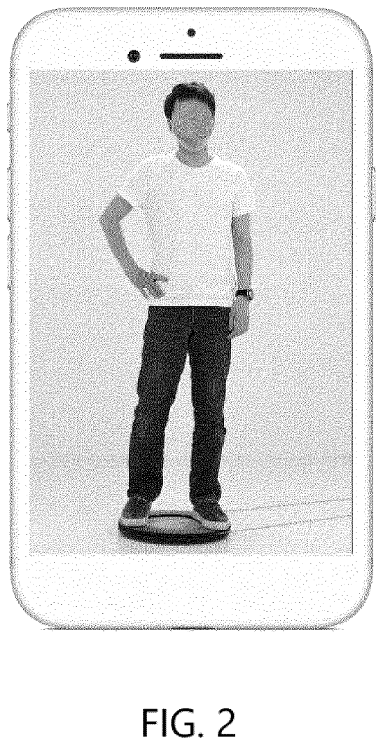

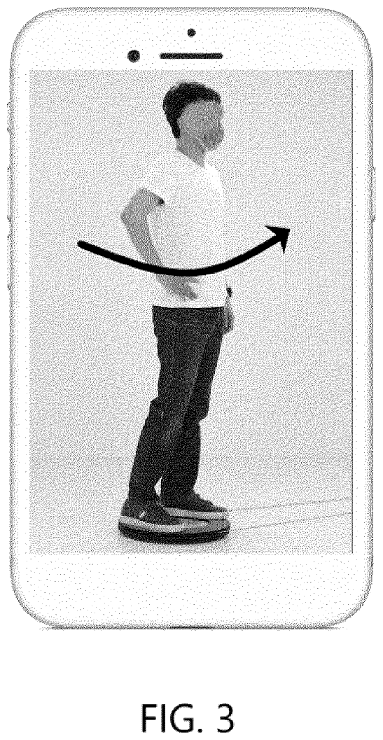

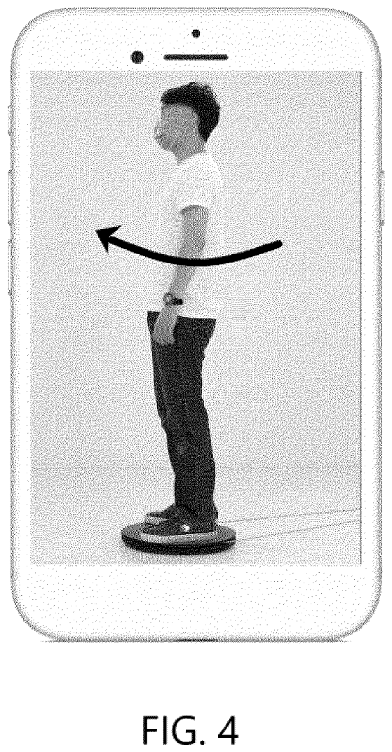

FIG. 1 is a diagram schematically illustrating a reproduction method for an image according to an exemplary embodiment of the present disclosure, FIG. 2 is a diagram schematically illustrating a screen of a smartphone to which the exemplary embodiment is applied, FIG. 3 is a diagram schematically illustrating an image figure of the screen illustrated in FIG. 2 which is rotated in a forward direction, and FIG. 4 is a diagram schematically illustrating the image figure of the screen illustrated in FIG. 2 which is rotated in a reverser direction.

As illustrated in the drawings, the reproduction method for the image according to the exemplary embodiment includes a step (S10) of generating a low-capacity image by rendering an image when uploading a photographed image of an object to be photographed through an accessed user terminal, and an image reproduction step (S20) of reproducing the low-capacity image to a display connected to a server or a user terminal, and counterclockwise rotation which is forward rotation of an image is provided by controlling a reproduction speed of the image, and clockwise rotation which is reverse rotation of the image is provided by reversely reproducing the image (S30).

In the exemplary embodiment, first, a step of photographing a 360-degree state of the object to be photographed with the image may be performed. In the exemplary embodiment, the object to be photographed may be photographed while rotating the object to be photographed or while rotating a camera around the object to be photographed, and when the object to be photographed is a model, the model may perform photographing while turning at a standstill.

Further, in the exemplary embodiment, the photographed image is used as by rendering a lower-capacity image than an image photographed upon uploading through the server or a user terminal accessing a specific program to reduce traffic on the Internet.

Specifically, the low-resolution image having the lower resolution than the photographed image, that is, the low-capacity image may be additionally rendered and generated, and then the additionally rendered low-resolution image may be provided when the user accesses the corresponding image through the server or the user terminal. In this case, since the low-resolution image other than the high-resolution image is provided, the traffic may be reduced on the Internet. In the exemplary embodiment, the low-capacity image may occupy a capacity of approximately 10 to 80% of the capacity of the photographed image.

Meanwhile, in the exemplary embodiment, the counterclockwise rotation which is the forward rotation of the image may be provided by controlling the reproduction speed of the image having the low resolution, and the clockwise rotation which is the reverse rotation of the image may be made by reversely reproducing the image.

Specifically, the forward rotation of the object to be photographed may be made by increasing the speed of the image upon dragging by a mouse or touch scheme from a left side to a right side in a screen of a computer or a laptop or a smart device (smartphone/tablet). Further, the reverse rotation of the object to be photographed may be made by reversely reproducing the image upon dragging by the mouse or touch scheme from the right side to the left side in the screen.

Forward Rotation of Image

The forward rotation of the image may show an effect of directly dragging and rotating the image by adjusting the reproduction speed of the image when the mouse or an X coordinate of an event upon touching moves from the left side to the right side in the screen of the computer or the laptop or the smart device (smartphone/tablet).

That is, while the user drags the image by the mouse or the touch, the X coordinate of the event is acquired to measure the speed of the drag, and the reproduction speed is increased or decreased according to a ratio of the speed to rotate the image in the forward direction.

Reverse Rotation of Image

The reverse rotation of the image may show an effect of directly dragging and rotating the image by reversely reproducing the image when the mouse or an X coordinate of an event upon dragging by the mouse or touch moves from the right side to the left side in the screen of the computer or the laptop or the smart device (smartphone/tablet).

However, when a browser does not provide a reverse reproduction function, the reproduction speed of the image is set to ‘0’ or is changed to a pause state, and then the play time is forcibly changed according to movement of the mouse or the touch to make a similar effect to the reverse reproduction.

Since a time applied according to a network state or a specification of the device varies when changing the play time of the image, an error may occur when the play time is changed continuously within a short time.

A wrong processing example is disclosed in Table 1 below, and this is a case where 0.3 seconds are required for changing the play time of the image.

TABLE 1

| | Change | Value to be | Current | |
|---|---|---|---|---|
| Current time | value by event | processed by event | play time | |
| 19:0000:00 | −0.2. | Try to change play | 3 | seconds |
| | | time to 2.8 seconds | | |
| 19:0000:02 | −0.2. | Try to change to 2.6 | 3 | seconds |
| | | in uncompleted state | | |
| | | because 0.3 seconds | | |
| | | do not elapse | | |
| 19:0000:04 | −0.2. | Try to change to 2.4 | 3 | seconds |
| | | in uncompleted state | | |
| | | because 0.3 seconds | | |
| | | do not elapse | | |
| 19:0000:06 | −0.2. | Try to change to 2.2 | 3 | seconds |
| | | in uncompleted state | | |
| | | because 0.3 seconds | | |
| | | do not elapse | | |
| 19:0000:08 | −0.2. | Try to change to 2.0 | 3 | seconds |
| | | in uncompleted state | | |
| | | because 0.3 seconds | | |
| | | do not elapse | | |
| 19:0000:10 | −0.2. | Try to change to 1.8 | 3 | seconds |
| | | in uncompleted state | | |
| | | because 0.3 seconds | | |
| | | do not elapse | | |
| 19:0000:12 | −0.2. | Try to change to 1.6 | 3 | seconds |
| | | in uncompleted state | | |
| | | because 0.3 seconds | | |
| | | do not elapse | | |
| 19:0000:15 | — | Change to 1.6 after | 1.6 | seconds |
| | | 0.3 seconds elapse | | |
| | | from step | | |

When trying to continuously change the play time in a state in which the play time of the image is tried to be changed as in Table 1 above, a problem in that the play time of the image is changed from 3 seconds to 1.6 seconds may occur. In the exemplary embodiment, the following method may be added in order to solve the problem.

Only when a continuous reverse reproduction event occurs and it is thus possible to change the play time of the image which is executed previously when the play time of the image is changed, changing the play time of the image is tried again, and otherwise, after the play time of the image to be changed is added, the added play time may be applied jointly when the play time of a next image is changed.

TABLE 2

| | Change | Value to be | Current | |
|---|---|---|---|---|
| Current time | value by event | processed by event | play time | |
| 19:0000:00 | −0.2. | Try to change play time | 3 | seconds |
| | | to 2.8 seconds | | |
| 19:0000:02 | −0.2. | Uncompleted state because | 3 | seconds |
| | | 0.3 seconds do not | | |
| | | elapse −0.2 is stored | | |
| | | in a variable, which is | | |
| | | not tried to be changed | | |
| 19:0000:04 | −0.2. | Since 0.4 seconds elapse | 2.8 | seconds |
| | | in a first step of trying | | |
| | | to change last, changing | | |
| | | to 2.8 is completed, and | | |
| | | 2.8 is tried to be changed | | |
| | | to 2.4 which is a value | | |
| | | acquired by executing −0.4 | | |
| | | by adding −0.2 which is not | | |
| | | executed in a second step | | |
| 19:0000:06 | −0.2. | Uncompleted state because | 2.8 | seconds |
| | | 0.3 seconds do not | | |
| | | elapse −0.2 is stored | | |
| | | in a variable, which is | | |
| | | not tried to be changed | | |
| 19:0000:08 | −0.2. | Since 0.4 seconds elapse | 2.4 | seconds |
| | | in a third step of trying | | |
| | | to change last, changing | | |
| | | to 2.4 is completed, and | | |
| | | 2.4 is tried to be changed | | |
| | | to 2.0 which is a value | | |
| | | acquired by executing −0.4 | | |
| | | by adding −0.2 which is not | | |
| | | executed in a fourth step | | |
| 19:0000:10 | −0.2. | Uncompleted state because | 2.4 | seconds |
| | | 0.3 seconds do not | | |
| | | elapse −0.2 is stored | | |
| | | in a variable, which is | | |
| | | not tried to be changed | | |
| 19:0000:12 | −0.2. | Since 0.4 seconds elapse | 2.0 | seconds |
| | | in a fifth step of trying | | |
| | | to change last, changing | | |
| | | to 2.0 is completed, and | | |
| | | 2.0 is tried to be changed | | |
| | | to 1.6 which is a value | | |
| | | acquired by executing −0.4 | | |
| | | by adding −0.2 which is not | | |
| | | executed in a sixth step | | |
| 19:0000:15 | — | Changing to 1.6 after 0.3 | 1.6 | seconds |
| | | seconds elapse | | |

In the exemplary embodiment, in the state in which the change of the play time of the image is not completed (or in the state in which the play time is being changed), the change is not tried, but values are collected and the change is executed at once when the change is possible next to implement stepwise reverse rotation (reverse reproduction). Meanwhile, in the exemplary embodiment, a magnification function may be actuated based on the coordinate where the event occurs when magnifying the image. The above-described magnification may be implemented as a wheel operation in the computer or the laptop, and a magnification motion in the smart device (smartphone/tablet), or a separate interface. However, since the quality of the image is low even though the low-resolution image is magnified, the following method may be used.

First, when the magnification event of the image occurs, the reproduction speed of the image is set to ‘0’ or the current play time is checked after pause.

Next, while the size of the corresponding image is increased as many as the magnification event occurs, a capture image of the current play time of the original high-definition image is imported asynchronously.

Last, the current play time capture image is overlaid on the magnified image.

In the exemplary embodiment, when the image is first magnified by the above-described procedure, the image is blurry and imported and overlaid with the capture image, the high-definition image appears, thereby obtaining a high-quality magnification image.

However, a cache is made to the server or browser so that an original image need not be captured again in the same play time and when the magnification event occurs at the same play time, a cache image may be used in the server or browser again.

In this case, in normal times, the low-resolution image is used, and only when the image is magnified, the cache image is used, so a traffic reduction effect may be obtained.

In addition, in the exemplary embodiment, when there is no event such as the touch or the drag, i.e., no motion for a specific time, the image may stop or may be operated by a separate interface.

The present disclosure is not limited to the exemplary embodiments described herein, and it would be apparent to those skilled in the art that various changes and modifications can be made without departing from the spirit and the scope of the present disclosure. Therefore, it should be said that such modifications or variations fall within the scope of the claims of the present disclosure.

The exemplary embodiment may provide a reproduction method for an image which can rotate an image without a stop phenomenon upon forward rotation or reverse rotation of the image in a screen of a website.

What is claimed is:

1. A reproduction method for an image, comprising:
generating a low-capacity image by rendering a photographed image of an object to be photographed by a user; and
reproducing the low-capacity image in a display connected to a server or a user terminal by the user,
wherein counterclockwise rotation which is forward rotation of the image is provided by controlling a reproduction speed of the image, and
clockwise rotation which is reverse rotation of the image is provided by reversely reproducing the image.

2. The reproduction for an image of claim 1, wherein only when a continuous reverse reproduction event occurs and it is thus possible to change the play time of the image which is executed previously when the play time of the image is changed, changing the play time of the image is tried again, and otherwise, after the play time of the image to be changed is added, the added playtime is applied jointly when the playtime of a next image is changed.

3. The reproduction for an image of claim 1, wherein in the forward rotation, while the image is dragged by a mouse or a touch, an arbitrary dragged coordinate is obtained and a coordinate speed is measured, and a sped of the forward rotation is increased or decreased according to a ratio of the coordinate speed.

4. The reproduction for an image of claim 1, wherein magnification of the image is provided by overlaying a current play time capture image of an original high-definition image on the image having the low-resolution.

5. The reproduction for an image of claim 4, wherein the magnification of the image includes
setting the reproduction speed of the image to ‘0’ or checking the current play time after pause when magnifying the image,
importing the current play time capture image of the original high-definition image through the server or the user terminal, and
overlaying the current play time capture image on the magnified image.

6. The reproduction for an image of claim 1, wherein the image having the low resolution is used when not magnifying the image, and
a cache image made in the server or browser is used when magnifying the image.
